(19) United States
(12) Patent Application Publication
(10) Pub. No.: US 2008/0093930 A1
(43) Pub. Date: Apr. 24, 2008

(54) Uninterruptible power supply device

(75) Inventor: Robert Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/586,447

(22) Filed: Oct. 24, 2006

(51) Int. Cl. H02J 9/00

(52) U.S. Cl. 307/66

(57) ABSTRACT

An uninterruptible power supply device is proposed, which is designed for use in conjunction with an electronic system, such as a network server or a desktop computer, for providing an uninterruptible power supply to the electronic system. The proposed uninterruptible power supply device is characterized by the provision of a battery adaptation and management capability that allows the user to employ various types of battery units to serve as the backup power supplies. This feature allows the utilization of the uninterruptible power supply to be more flexible and convenient, and also can help solve the problem of shortened life of the battery unit due to the switching of multiple loads to the backup battery unit in the event of a failure in the main power supply.

### BACKGROUND OF THE INVENTION

1. Field of the Invention

This invention relates to power supply technology, and more particularly, to an uninterruptible power supply device which is designed for use in conjunction with an electronic system, such as a network server or a desktop computer, for providing the electronic system with an uninterruptible power supply capability.

2. Description of Related Art

UPS (Uninterruptible Power Supply) devices are widely utilized with computer platforms, such as network servers or desktop computer, for supplying an electrical power in an uninterruptible manner. A UPS device operates in such a manner that in the event of a failure to the main power source, typically the utility power, it can immediately switch the computer to a backup power source, such as a battery or a local power generator. This can help prevent permanent data loss in the computer due to an unexpected power failure.

Presently, many various types of UPS devices have been developed for use with network servers. These UPS devices typically utilize a battery as the backup power source. One drawback to these UPS devices, however, is that the switching of the power connection from the main power source to the battery requires the use of a switching loop composed of a plurality of control devices and other circuit elements that are quite power consumptive. This high level of power consumption would cause the battery to be quickly drained out of power and thus cannot provide a long-time power supply to the network server.

Moreover, another drawback to the present UPS devices is that the battery unit is preinstalled by the manufacturer with a fixed type and thus cannot be arbitrarily replaced by the user to any other types of batteries.

### SUMMARY OF THE INVENTION

It is therefore an objective of this invention to provide an uninterruptible power supply device which allows the switching of the main power source to the backup power source to be less power consumptive, so that the backup power source (i.e., battery) can be used to provide a long-time power supply to the network server.

It is another objective of this invention to provide an uninterruptible power supply device which allows the user to utilize various types of batteries as the backup power source.

The uninterruptible power supply device according to the invention comprises: (A) a main power supply module, which is used for connection to an external power supply system for converting the output power of the external power supply system into a DC voltage and forwarding the DC voltage to an output port; (B) a battery adaptation module, which is connectable to an external battery unit for fetching a battery-supplied DC voltage therefrom, where the battery-supplied DC voltage is smaller in magnitude than the output DC voltage from the external power supply system; (C) a battery power management module, which is capable of providing a power management function for the battery unit connected to the battery adaptation module; (D) a power failure detection module, which is capable of detecting whether the output DC voltage from the output port is smaller than a predefined bottom limit; and if yes, capable of generating a switching enable signal; and (E) a power switching module, which includes a first circuit and a second circuit, and which operates in such a manner that when the external power supply system operates normally, both the first circuit and the second circuit are in a disconnected state, and when the output DC voltage from the battery unit is greater than the output DC voltage from the main power supply module, the first circuit is switched to a connected state and thereby causes the output DC voltage from the battery adaptation module to be transferred to the output port, causing the power switching module to generate a switching enable signal and the second circuit to respond to the switching enable signal by being switched to a connected state, allowing the output DC voltage from the battery adaptation module to be redirected through the second circuit to the output port and onwards to the electronic system.

The uninterruptible power supply device according to the invention is characterized by the provision of a battery adaptation and management capability that allows the user to employ various types of battery units to serve as the backup power supplies. This feature allows the utilization of the uninterruptible power supply to be more flexible and convenient, and also can help solve the problem of shortened life of the battery unit due to the switching of multiple loads to the backup battery unit in the event of a failure in the main power supply.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the uninterruptible power supply device according to the invention; and

FIG. 2 is a schematic diagram showing a preferred embodiment of a control panel on the uninterruptible power supply device of the invention.

### DETAILED DESCRIPTION OF PREFERRED EMBODIMENTS

The uninterruptible power supply device according to the invention is disclosed in full details by way of preferred embodiments in the following with reference to the accompanying drawings.

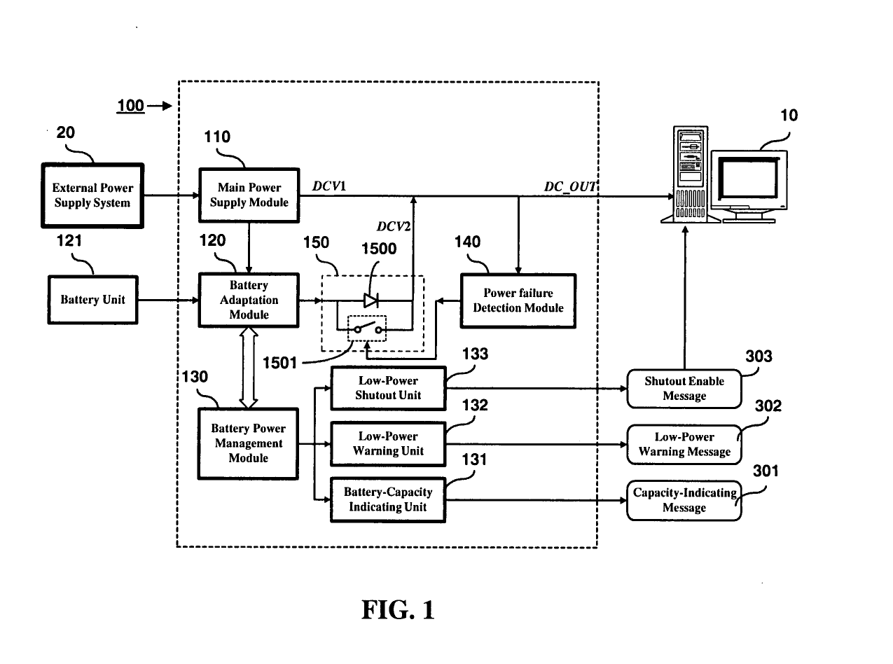

FIG. 1 is a schematic diagram showing the system architecture of the uninterruptible power supply device according to the invention (which is the part encapsulated in the dotted box designated by the reference numeral 100). As shown, the uninterruptible power supply device of the invention 100 is designed for use in conjunction with an electronic system 10, such as a network server or a desktop computer (in the following embodiment, it is assumed that the network server 10 is a network server), for providing the network server 10 with an uninterruptible power supply. In application, the uninterruptible power supply device of the invention 100 is connected to an external power supply system 20, such as a utility power system or a local power generator. In normal operation, the uninterruptible power supply device of the invention 100 utilizes the external power supply system 20 as a main power source to supply a DC (direct current) voltage to the network server 10; and in the event of a failure to the external power supply system 20, the uninterruptible power supply device of the invention 100 is nonetheless able to supply a DC voltage to the network server 10 by means of a battery unit 121.

As shown in FIG. 1, in architecture, the uninterruptible power supply device of the invention 100 comprises: (A) a main power supply module 110; (B) a battery adaptation module 120; (C) a battery power management module 130; (D) a power failure detection module 140, and (E) a power switching module 150. Firstly, the respective attributes and behaviors of these components 110, 120, 130, 140, 210 are described in details in the following.

The main power supply module 110 is used for connection to an external power supply system 20 and capable of converting the output power (typically an AC power) of the external power supply system 20 into a DC voltage DCV1 and then supplying the DC voltage DCV1 via an output port DC_OUT to the network server 10.

The battery adaptation module 120 is used for connection to a battery unit 121, preferably a rechargeable battery unit, and utilizes the battery unit 121 for fetching the battery-supplied DC voltage DCV2 therefrom as a backup power source. In the event of a failure to the external power supply system 20, the output DC voltage DCV2 of the battery unit 121 will be transferred via the output port DC_OUT to the network server 10. The battery unit 121 that can be connected to the battery adaptation module 120 is selected from the group comprising lead storage battery, fuel battery, and solar cell battery, to name just a few. The battery unit 121 can be preinstalled by the manufacturer to the uninterruptible power supply device of the invention 100 in factory, or installed by the user after purchase. The battery unit 121 is preferably a rechargeable battery unit, such that when it is installed in position in the uninterruptible power supply device of the invention 100, it can be charged by the DC power from the main power supply module 110 fetched from the external power supply system 20. Typically, the battery-supplied DC voltage DCV1 from the battery adaptation module 120 is smaller in magnitude than the output DC voltage DCV1 of the main power supply module 110 fetched from the external power supply system 20.

The battery power management module 130 is capable of providing a set of power management functions for the battery unit 121 connected to the battery adaptation module 120, including, for example, a battery-capacity indicating function, a low-power warning function, and a low-power shutout function, which are respectively provided by a battery-capacity indicating unit 131, a low-power warning unit 132, and a low-power shutout unit 133.

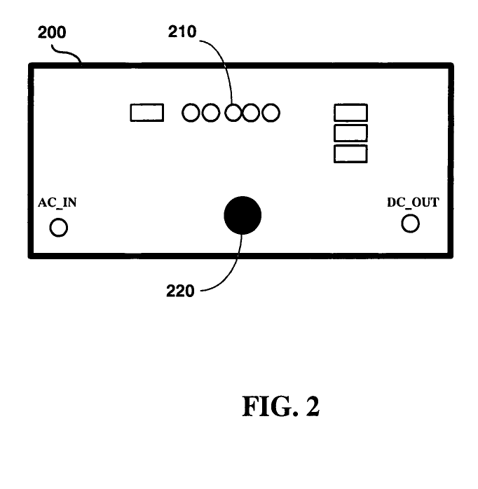

The battery-capacity indicating unit 131 is capable of indicating the current charge capacity of the battery unit 121 connected to the battery adaptation module 120 in a human-perceivable form, so as to allow the user to learn the current charge capacity of the battery unit 121. In practical implementation, for example, this battery-capacity indicating unit 131 utilizes a 5-level indicating scheme to generate a capacity-indicating message 301, by which the total charge capacity of the battery adaptation module 120 is divided into 5 levels, and an array of light-emitting diodes (LED) 210 consisting of 5 LEDs as shown in FIG. 2 is provided on the control panel 200 for indicating the 5 levels of battery capacity. In this embodiment, for example, the LED array 210 operates in such a manner that when the battery unit 121 is fully charged, all of the 5 LEDs are lit up; when 80% charged, only 4 of the 5 LEDs are lit up; when 60% charged, only 3 of the 5 LEDs are lit up; and so forth.

The low-power warning unit 132 is used to provide the battery adaptation module 120 with a low-power warning function that can be activated in the event that the charge capacity of the battery adaptation module 120 is lower than a predefined bottom limit, such as 15% of full capacity. When activated, the low-power warning unit 132 is capable of generating a low-power warning message 302 to inform the user to take necessary actions on the network server 10, such as turning off the network server 10 or change the battery unit 121. In practical implementation, for example, this low-power warning unit 132 utilizes a 2-stage warning scheme, by which the 15% level is defined as the first stage and the 10% level is defined as the second stage, and a buzzer 220 is provided on the control panel 200 as shown in FIG. 2 which will generate a sequence of buzzing sounds at a rate of, for example, 7 seconds in the first stage and 3 seconds in the second stage.

The low-power shutout unit 133 is used to provide the network server 10 with a low-power shutout function that can shut out the network server 10 in the event of the capacity of the battery unit 121 reaches a critical low level, such as 5% of full capacity. When activated, the low-power shutout unit 133 issues a shutout enable message 303 to the network server 10, which will cause the network server 10 to perform a shutout procedure.

The power failure detection module 140 is capable of detecting whether the output DC voltage DCV1 from the main power supply module 110 is interrupted due to a failure to the external power supply system 20; and if yes, capable of generating a switching enable signal to the power switching module 150. In practical implementation, for example, the power failure detection module 140 can be either a relay or a transistor switch. Fundamentally, when the power failure detection module 140 detects that the output voltage from the output port DC_OUT is smaller than the output DC voltage DCV1 of the main power supply module 110, it will issue a switching enable signal.

The power switching module 150 is capable of being activated in response to an event of the battery-supplied DC voltage DCV2 from the battery unit 121 being greater in magnitude than the output DC voltage DCV1 from the main power supply module 110 (i.e., an event of a failure to the external power supply system 20) to switch the battery-supplied DC voltage DCV2 to the output port DC_OUT, such that the battery-supplied DC voltage can be used to power the network server 10 in the event of a failure to the external power supply system 20. In practical implementation, for example, the power switching module 150 is composed of a first circuit such as a Schottky diode 1500 and a second circuit such as a relay device 1501, wherein the Schottky diode 1500 has a positive end connected to the output of the battery adaptation module 120 and a negative end connected to the output port DC_OUT, and the relay device 1501 has a control end connected to the power failure detection module 140 and an input end and an output end connected across the Schottky diode 1500. Under normal conditions (i.e., when the external power supply system 20 operates normally), the Schottky diode 1500 and the relay device 1501 are both set at a nonconductive state; and in the event of a failure to the external power supply system 20, it will cause the output DC voltage DCV1 to be smaller than the battery-supplied DC voltage DCV2 from the battery unit 121, thereby causing the Schottky diode 1500 to be set at a conductive state, thus allowing the battery-supplied DC voltage DCV2 to be supplied from the battery adaptation module 120 to the output port DC_OUT. When the battery-supplied DC voltage DCV2 is being supplied to the output port DC_OUT, the power failure detection module 140 will be activated by DCV2 to output a switching enable signal to the power switching module 150, which causes the relay device 1501 to be set at a connected state (ON) and therefore allows DCV2 to be transferred by way of the relay device 1501 to the output port DC_OUT. As a result, the battery-supplied DC voltage from the battery unit 121 can be supplied via the battery adaptation module 120 and the power switching module 150 to the output port DC_OUT and onwards to the network server 10. In this way, the battery-supplied DC voltage DCV2 can be supplied without passing through the Schottky diode 1500 which would consume some amount of the battery-supplied power and thus makes the power transfer to be less inefficient.

Moreover, by using the Schottky diode 1500 in the power switching module 150, it allows the battery-supplied DC voltage DCV2 to be supplied to the network server 10 in the event of a failure to the external power supply system 20 in a same rail manner without having a switching loop. This feature allows the power switching module 150 to have an increased switching speed.

The following is a detailed description of a practical application example of the uninterruptible power supply device of the invention 100 during actual operation. In this application example, it is assumed that the uninterruptible power supply device of the invention 100 is used to supply electrical power to a network server 10.

When the external power supply system 20 operates normally, the main power supply module 110 will convert the AC power from the external power supply system 20 into a DC voltage DCV1 and transfer DCV1 via the output port DC_OUT to the network server 10.

In the event of a failure to the external power supply system 20, it will cause the output DC voltage DCV1 from the main power supply module 110 to be interrupted. This condition will be detected by the power failure detection module 140 and responsively issue a switching enable signal to the power switching module 150, thereby activating the power switching module 150 to switch the battery-supplied DC voltage DCV2 from the battery unit 121 to the output port DC_OUT. As a result, the network server 10 can be nonetheless powered by DCV2 when the external power supply system 20 fails.

During the operation of the battery unit 121, the battery power management module 130 is activated to provide a set of power management functions for the battery unit 121, including a battery-capacity indicating function, a low-power warning function, and a low-power shutout function.

The battery-capacity indicating unit 131 provides a 5-level indicating function to generate a capacity-indicating message 301, by which the total charge capacity of the battery adaptation module 120 is divided into 5 levels, and an array of light-emitting diodes (LED) 210 consisting of 5 LEDs as shown in FIG. 2 is provided on the control panel 200 for indicating the 5 levels of battery capacity, in such a manner that when the battery unit 121 is fully charged, all of the 5 LEDs are lit up; when 80% charged, only 4 of the 5 LEDs are lit up; when 60% charged, only 3 of the 5 LEDs are lit up; and so forth. The low-power warning unit 132 is used to provide the battery adaptation module 120 with a low-power warning function that can be activated in the event of the charge capacity of the battery adaptation module 120 is lower than a predefined bottom limit, such as 15% of full capacity. When activated, the low-power warning unit 132 provides a 2-stage warning function, by which a buzzer 220 will generate a sequence of buzzing sounds at a rate of 7 seconds when the remaining charge capacity is 15%, and at a rate of 3 seconds when the remaining charge capacity is 10%. The low-power shutout unit 133 is used to provide a low-power shutout function that can automatically shut out the network server 10 in the event that the capacity of the battery unit 121 reaches a critical low level, such as 5% of full capacity. When activated, the low-power shutout unit 133 issues a shutout enable message 303 to the network server 10, which will cause the network server 10 to respond by performing a shutout procedure.

In conclusion, the invention provides an uninterruptible power supply device for use with an electronic system, such as a network server or a desktop computer, for providing an uninterruptible power supply to the electronic system, and which is characterized by the provision of a battery adaptation and management capability that allows the user to employ various types of battery units to serve as the backup power supplies. This feature allows the utilization of the uninterruptible power supply to be more flexible and convenient, and also can help solve the problem of shortened life of the battery unit due to the switching of multiple loads to the backup battery unit in the event of a failure in the main power supply. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An uninterruptible power supply device for use with a electronic system for providing a uninterruptible power supply capability, which comprises:
a main power supply module, which is used for connection to an external power supply system for converting the output power of the external power supply system into a DC voltage and forwarding the DC voltage to an output port;
a battery adaptation module, which is used for connection to an external battery unit for fetching a battery-supplied DC voltage therefrom, where the battery-supplied DC voltage is smaller in magnitude than the output DC voltage from the external power supply system;
a battery power management module, which is capable of providing a power management function for the battery unit connected to the battery adaptation module;
a power failure detection module, which is capable of detecting whether the output DC voltage from the output port is smaller than a predefined bottom limit; and if yes, capable of generating a switching enable signal; and
a power switching module, which includes a first circuit and a second circuit, and which operates in such a manner that when the external power supply system operates normally, both the first circuit and the second circuit are in a disconnected state, and when the output DC voltage from the battery unit is greater than the output DC voltage from the main power supply module, the first circuit is switched to a connected state and thereby causes the output DC voltage from the battery adaptation module to be transferred to the output port, causing the power switching module to generate a switching enable signal and the second circuit to respond to the switching enable signal by being switched to a connected state, allowing the output DC voltage from the battery adaptation module to be redirected through the second circuit to the output port and onwards to the electronic system.

2. The uninterruptible power supply device of claim 1, wherein the first circuit is a diode while the second circuit is a relay device, wherein the diode has a positive end connected to the output of the battery adaptation module and a negative end connected to the output port, and the relay device has a control end connected to the power failure detection module and an input end and an output end connected across the diode.

3. The uninterruptible power supply device of claim 1, wherein the predefined bottom limit is the magnitude of the output DC voltage from the main power supply module converted from the output power of the external power supply system.

4. The uninterruptible power supply device of claim 1, wherein the battery unit connected to the battery adaptation module is a lead storage battery.

5. The uninterruptible power supply device of claim 1, wherein the battery unit connected to the battery adaptation module is a fuel battery.

6. The uninterruptible power supply device of claim 1, wherein the battery unit connected to the battery adaptation module is a solar cell battery.

7. The uninterruptible power supply device of claim 1, wherein the battery power management module includes a battery-capacity indicating unit for indicating the capacity of the battery unit.

8. The uninterruptible power supply device of claim 7, wherein the battery-capacity indicating unit includes an array of light-emitting diodes which are lit up in a predefined pattern to indicate the current capacity of the battery unit.

9. The uninterruptible power supply device of claim 1, wherein the battery power management module includes a low-power warning unit for generating a low-power warning message when the capacity of the battery unit reaches a bottom limit.

10. The uninterruptible power supply device of claim 9, wherein the low-power warning unit includes a buzzer for generating a sequence of buzzing sounds at a predefined rate as the warning message.

11. The uninterruptible power supply device of claim 1, wherein the battery power management module includes a low-power shutout unit for triggering the electronic system to perform a shutout procedure when the capacity of the battery unit reaches a critically-low limit.
